(19) United States
(12) Patent Application Publication
(10) Pub. No.: US 2012/0168546 A1
(43) Pub. Date: Jul. 5, 2012

(54) GRINDING APPARATUS AND METHODS OF MAKING AND USING SAME

(76) Inventor: Gary Mays, Bartlesville, OK (US)

(21) Appl. No.: 13/336,231

(22) Filed: Dec. 23, 2011

Related U.S. Application Data
(60) Provisional application No. 61/429,661, filed on Jan. 4, 2011.

(51) Int. Cl. B02C 23/00; B23P 21/00

(52) U.S. Cl. 241/285.2; 29/428

(57) ABSTRACT

A grinding apparatus having a housing capable of being removably attached to an upper journal housing of a pulverizer. The housing has an open first end, a closed second end, an outer peripheral surface, and a sidewall. The outer peripheral surface has a grinding portion for grinding a solid fuel. The sidewall defines an oil chamber sized and configured to receive a shaft of the pulverizer.

### CROSS-REFERENCE TO RELATED APPLICATIONS

The present application claims benefit under 35 U.S.C. §119(e) of U.S. Provisional Application Ser. No. 61/429,661, filed Jan. 4, 2011, which is hereby expressly incorporated herein by reference in its entirety.

### FIELD OF THE INVENTION

The present invention relates generally to a grinding apparatus for pulverizing a solid fuel, and more particularly, but not by way of limitation, to an improved grinding apparatus for pulverizing a solid fuel and a method of making and using the grinding apparatus.

### BACKGROUND OF THE INVENTION

Pulverizers are well known for reducing the particle size of solid fuel to allow for combustion of the solid fuel. Examples of solid fuel include coal, wood, charcoal, peat, corn, wheat, other grains, and the like. Various types of pulverizer mills are utilized, such as bowl mills, ball-tube mills, impact mills, attrition mills, ring roll mills, or the like.

Typically, bowl mills have a grinding ring carried by a rotating bowl which forms a grinding table surface. At least one grinding roll is fixedly mounted on a shaft and journal assemblies such that the surface of at least one grinding roll is urged towards the grinding table surface by an adjustable spring, hydraulics, or the like. Journal bearings allow rotation of the journal assemblies relative to the shaft. The grinding roll crushes solid fuel caught between the surface of the grinding roll and the grinding table surface.

Grinding a solid fuel, such as coal, is difficult because coal is such an abrasive material. The material causes problems with both erosion and abrasion to the equipment which grinds the material, such as the grinding rolls. Many pulverizer parts are routinely replaced because of wear to the parts. The replacement, rebuild, and/or maintenance of the equipment have a direct impact to the cost of an operation due to the equipment being off-line for periods of time. Reducing wear on the grinding roll and/or other components reduces both the time required to be off-line and the costs for performing maintenance.

Maintenance of pulverizers causes considerable delays also due to the difficulty in removing and replacing journal assemblies and grinding rolls which are considerably heavy. Not only is the removal and installation of journal assemblies and grinding rolls difficult, but also time-consuming and dangerous.

To this end, although journal assemblies and grinding rolls of the existing art are operable, further improvements are desirable and a need remains to provide a grinding apparatus and method of use whereby the journal assembly and grinding roll may be removed and replaced in such a way to improve the safety and ease of replacement without taper fitting problems. It is to such a grinding apparatus and method of making and using that at least one embodiment of the present invention is directed.

### SUMMARY OF THE INVENTION

The present invention is directed to a grinding apparatus for pulverizing solid fuel, like coal. The grinding apparatus has a housing capable of being removably attached to an upper journal housing of a pulverizer. The housing has an open first end, a closed second end, an outer peripheral surface, and a sidewall. The first end of the housing has a flange portion which has a plurality of holes for attaching the housing to the upper journal housing. The second end of the housing is provided with an outwardly extending shoulder portion. The outer peripheral surface has a grinding portion for grinding a solid fuel. The sidewall defines an oil chamber sized and configured to receive a shaft of the pulverizer. The grinding portion is formed from tungsten carbide. In one embodiment, the grinding portion is a weld overlay. The weld overlay is at least about 1.5 inches. The grinding portion may be integrally formed as a portion of the housing. In one embodiment, the sidewall extends outwardly from a proximal end to a distal end of the sidewall to form an outer portion of the oil chamber. The oil chamber is sized and configured to receive various sized shafts.

The housing of the grinding apparatus is removably attached to a conventional pulverizer for grinding a solid fuel. The first end of the housing has a flange portion having a plurality of holes for attachment of the housing to the upper journal housing of the pulverizer. A grinding roll of the pulverizer is removed. A lower journal assembly of the pulverizer is removed. A shaft of the pulverizer is disposed into the oil chamber of the housing of the grinding apparatus. The oil chamber of the housing of the grinding apparatus is filled with oil.

### BRIEF DESCRIPTION OF THE SEVERAL VIEWS OF THE DRAWINGS

FIG. 1 is a cross-sectional side elevation view of a conventional bowl mill pulverizer.

FIG. 2 is a cross-sectional view of a journal assembly of the conventional bowl mill pulverizer of FIG. 1.

FIG. 3a is a perspective view of one embodiment of a grinding apparatus constructed in accordance with the present invention.

FIG. 3b is a perspective sectional view of the grinding apparatus of FIG. 3a.

FIG. 4 is an end view of one embodiment of a grinding apparatus constructed in accordance with the present invention.

FIG. 5 is a sectional view of the grinding apparatus of FIG. 4 taken substantially along 5-5 in FIG. 4.

FIG. 6 is an end view of another embodiment of a grinding apparatus constructed in accordance with the present invention.

FIG. 7 is a sectional view of the grinding apparatus of FIG. 6 taken substantially along 7-7 in FIG. 6.

FIG. 8 is a cross-sectional view of another embodiment of a grinding apparatus mounted to a shaft of a pulverizer constructed in accordance with the present invention.

FIG. 9 is an end view of another embodiment of a grinding apparatus constructed in accordance with the present invention.

FIG. 10 is a sectional view of the grinding apparatus of FIG. 9 taken substantially along 10-10 in FIG. 9.

### DETAILED DESCRIPTION OF THE INVENTION

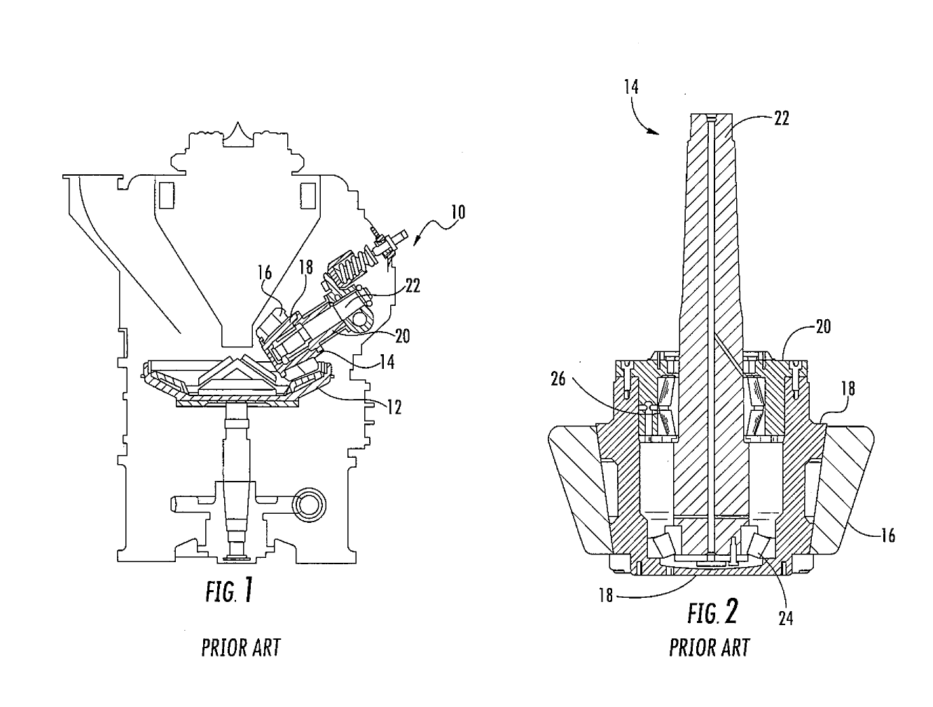

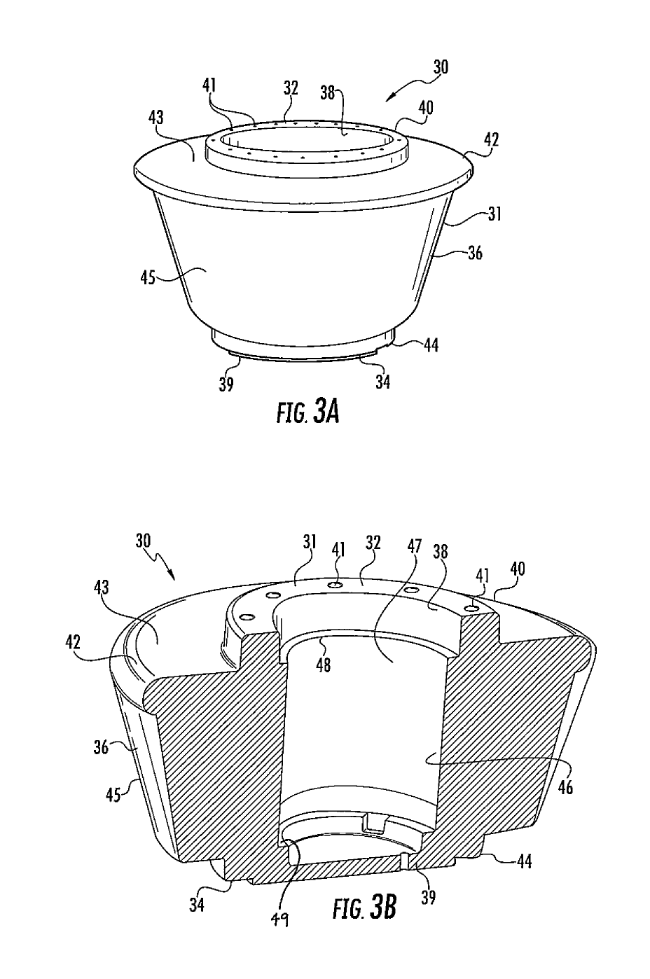

Referring now to the drawings, and more particularly to FIGS. 1 and 2, a conventional pulverizing bowl mill 10 is shown. Broadly, the bowl mill pulverizer 10 includes a grinding table 12, a journal assembly 14, and at least one grinding roll 16. A solid fuel material is fed onto the surface of the grinding table 12 and is pulverized by the at least one grinding roll 16.

The journal assembly 14 includes a lower journal housing 18 and an upper journal housing 20. The at least one grinding roll 16 is coupled to the lower journal housing 18, which in turn, is coupled to the upper journal housing 20. The lower and upper journal housings 18 and 20 receive a shaft 22 therethrough via a lower journal bearing(s) 24 and an upper journal bearing(s) 26 disposed at the lower and upper journal housings 18 and 20, respectively. It will be appreciated that pulverizing bowl mills are well known in the art. It is not believed necessary to describe the bowl mill pulverizer 10 in further detail and is deemed sufficient for purposes of understanding the bowl mill pulverizer 10 in accordance with a grinding apparatus constructed in accordance with the present invention. Thus, no further description of the bowl mill pulverizer 10 components, assembly, construction, or operation is believed necessary for one skilled in the art to understand and implement the grinding apparatus of the present invention. For a more detailed description of a bowl mill pulverizer 10, reference is made to U.S. Pat. No. 3,138,337, issued to A. Bogot et al.

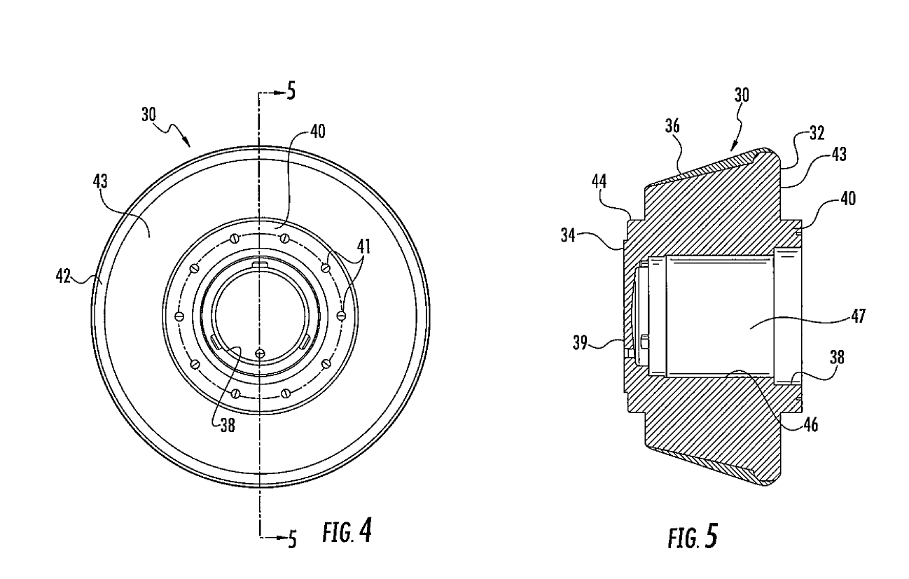

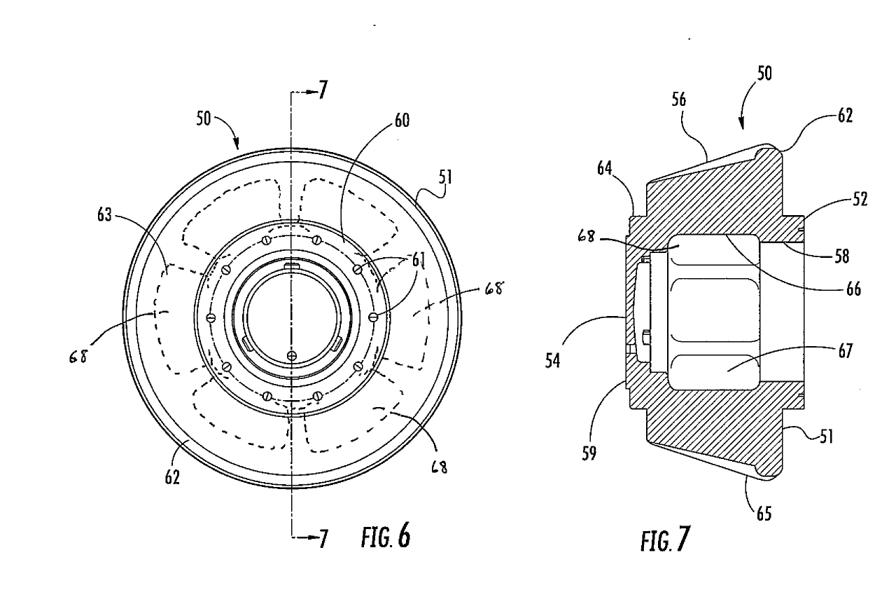

Referring now to FIGS. 3a-5, one embodiment of a grinding apparatus 30 is shown. The grinding apparatus 30 may be constructed from any material known by one of ordinary skill in the art which is strong enough to crush solid fuel material. It should be understood that the grinding apparatus 30 is constructed from one solid piece of material and/or multiple pieces of material. It may be constructed from any material or combination of materials known by one of ordinary skill in the art used to construct/fabricate journal assemblies, grinding rolls, and/or grinding apparatuses utilized in a pulverizer, such as cast steel (i.e. A216 A or B cast steel cores, rebuildable cast steel, both OD and ID), to prevent cracking. Further, it should be understood by one of ordinary skill in art that the grinding apparatus 30 may be any size and configuration to be utilized with any size and type of mill (by way of example, CE/Alstom 1103, CE/Alstom 1003, CE/Alstom 943, CE/Alstom 863, etc.) and/or shaft, and/or with any known type of journal housing.

The grinding apparatus 30 has a housing 31 provided with a first end 32, a second end 34, and an outer peripheral surface 36. The grinding apparatus 30 has an opening 38 at the first end 32 and a closed bottom 39 at the second end 34. The first end 32 of the grinding apparatus 30 is provided with a flange portion 40 having a plurality of holes 41 for attachment to an upper journal housing (like the upper journal housing 20 in FIGS. 1 and 2). Also, proximate the first end 32, is a rim 42 having a surface 43. The second end 34 is provided with an outwardly extending shoulder portion 44. For example, in one embodiment, the grinding apparatus 30 may be configured as follows, but not limited thereto: first end 32: R=24.0″; second end 34: R=18.6″ in relation to an angle of 18°. The outer peripheral surface 36 includes a grinding portion 45 which may be fabricated from any alloy having highly abrasive qualities, any abrasion-resistant material such as high chromium overlay or tungsten carbide. For example, in one embodiment, the grinding portion 45 is about 0.38 inches deep× about eight (8.0) inches long of tungsten carbide. It should be understood that the entire grinding surface from inside radius to outside radius may be covered. Also, specific wear areas on the entire surface could be enhanced. For example, a higher cost abrasion-resistant material may be applied in the highest wear area of the grinding surface and a lower cost abrasion-resistant material applied elsewhere. Additionally, any alloy from which the external surface of the grinding apparatus 30 is fabricated and is capable of being cast or applied in the form of a weld overlay or any other method known by one of ordinary skill in the art to improve the life of the grinding portion 45 of the grinding apparatus 30. For example, a weld overlay of at least about 1.5 inches is used in the highest wear areas. Some areas may required a greater or lesser overlay than at least about 1.5 inches. For example, it should be understood by one of ordinary skill in the art that the weld overlay may be less on a non-grinding portion of the outer peripheral surface 36 than that of the grinding portion 45. Additionally, it should be understood by one of ordinary skill in the art that the weld overlay will vary based on the type of material used to form the grinding portion 45 as well as the solid fuel being pulverized.

The grinding apparatus 30 has a sidewall 46 defining an interior space, cavity, or oil chamber 47. It should be understood that the thickness of the sidewall 46 varies based on the size of the grinding apparatus utilized. The oil chamber 47 of the sidewall 46 is sized and configured to receive a shaft utilized in a conventional pulverizer (like numeral 22 of FIG. 2). The oil chamber 47 includes a first seat 48 and a second seat 49. It should be understood by one of ordinary skill in the art that the oil chamber 47 may be sized and configured in various ways in order to receive any known shaft used in a pulverizer, so long as the present invention functions as described herein. The oil chamber 47 receives oil for providing lubrication between a conventional shaft and bearings (similar to that shown in FIG. 2).

In use, referring to FIGS. 2-5, when attaching the grinding apparatus 30 to the conventional upper journal housing 20, the grinding roll 16 is removed from a lower journal housing 18. The lower journal housing 18 is removed from the upper journal housing 20 and the shaft 22. The grinding apparatus 30 is then mounted to the shaft 22 and attached to the upper journal housing 20.

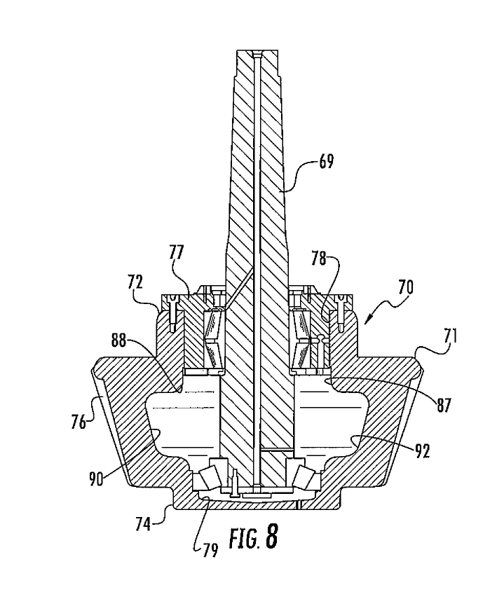

Referring now to FIGS. 6 and 7, another embodiment the grinding apparatus 50 is shown. The grinding apparatus 50 is similar to the grinding apparatus 30, except as described herein.

The grinding apparatus 50 has a housing 51 provided with a first end 52, a second end 54, and an outer peripheral surface 56. The grinding apparatus 50 has an opening 58 at the first end 52 and a closed bottom 59 at the second end 54. The first end 52 of the grinding apparatus 50 is provided with a flange portion 60 having a plurality of holes 61 for attachment to an upper journal housing of a pulverizer. The first end 52 also includes a rim 62 having a surface 63. The second end 54 is provided with an outwardly extending shoulder portion 64. The outer peripheral surface 56 includes a grinding portion 65 which may be fabricated from any alloy having highly abrasive qualities. Additionally, any alloy from which the external surface of the grinding apparatus 50 is fabricated is capable of being cast or applied in the form of a weld overlay or any other method known by one of ordinary skill in the art to improve the life of the grinding portion 65 of the grinding apparatus 50. For example, in one embodiment, the grinding apparatus 50 may be configured as follows, but not limited thereto: first end 52: R=24.0″; second end 54: R=18.6″ in relation to angle of 18°.

The grinding apparatus 50 also has a sidewall 66 defining an interior space, cavity, or oil chamber 67. The oil chamber 67 of the sidewall 66 is sized and configured to receive oil and a shaft utilized in a pulverizer. The oil chamber 67 is provided with a plurality of outwardly extending chamber portions 68. The outwardly extending chamber portions 68 have a radius of between about 14″ to about 16″. It should be understood by one of ordinary skill in the art that the oil chamber 67 may be configured to receive varying amounts of oil and any known shaft utilized in any known pulverizer so long as the present invention functions as described herein.

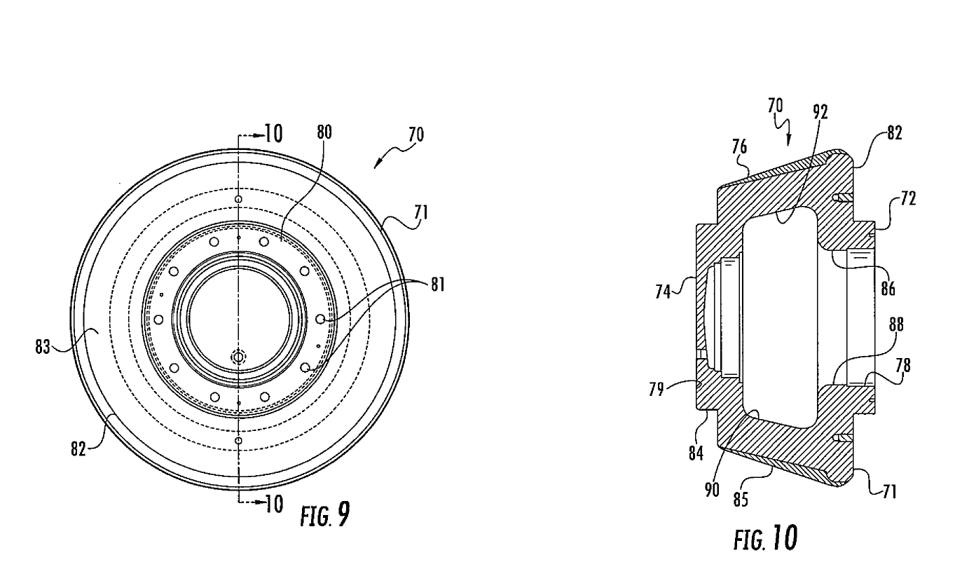

Referring now to FIGS. 8-10, shown therein is another embodiment of a grinding apparatus 70 mounted to a conventional shaft 69, the grinding apparatus 70 is constructed in accordance with the present invention. The grinding apparatus 70 is similar to the grinding apparatuses 30 and 50, except as described herein. The grinding apparatus 70 has a housing 71 provided with a first end 72, a second end 74, and an outer peripheral surface 76. The grinding apparatus 70 has an opening 78 at the first end 72 and a closed bottom 79 at the second end 74. The first end 72 of the grinding apparatus 70 is provided with a flange portion 80 having a plurality of holes 81 for attachment to an upper journal housing 77. Also, proximate the first end 72 is a rim 82 having a surface 83. The second end 74 is provided with an outwardly extending shoulder portion 84. The outer peripheral surface 76 includes a grinding portion 85 which may be fabricated from any alloy having highly abrasive qualities, any abrasion-resistant material such as high chromium overlay or tungsten. Additionally, any alloy from which the external surface of the grinding apparatus 70 is fabricated is capable of being cast or applied in the form of a weld overlay or any other method known by one of ordinary skill in the art to improve the life of the grinding portion 85 of the grinding apparatus 70. The weld overlay may be used in the highest wear areas. For example, in one embodiment, the grinding apparatus 70 may be configured as follows, but not limited thereto: first end 72: R=48.0″; second end 74: R=36.0″ in relation to an angle of 18°.

The grinding apparatus 70 also has a sidewall 86 defining an interior space, cavity, or oil chamber 87. The thickness of the sidewall 46 varies based on the size of the grinding apparatus utilized. For example, when a finished weight of the grinding apparatus is 5900 lbs., the thickness of the sidewall 46 is about 5.00 inches to about 5.25 inches.

The sidewall 86 extends outwardly from a proximal end 88 to a distal end 90 to form an outer portion 92 of the oil chamber 87. The oil chamber 87 of the sidewall 86 is sized and configured to receive a greater volume of oil than the cavity of a conventional journal housing. In one embodiment, the oil chamber 87 of the grinding apparatus 70 receives an oil volume between about 111 quarts and 125 quarts. The greater volume of oil provides for better lubrication when the grinding apparatus 70 is in operation. In one embodiment, operating oil levels vary between about 24 inches and about 28 inches. It should be understood by one of ordinary skill in the art that volume of oil may vary depending on the size of grinding apparatus 70 used in a pulverizer, so long as the present invention functions as described herein.

In use, referring to FIGS. 8-10, when assembling the grinding apparatus 70 to the conventional upper journal housing 77, a grinding roll (not shown) is removed from a lower journal housing (not shown). The lower journal housing is removed from the upper journal housing 77 and the shaft 69. The grinding apparatus 70 is then mounted to the shaft 69 and attached to the upper journal housing 77. It should be understood by one of ordinary skill in the art that the grinding apparatus 70 is assembled to the conventional upper journal housing 77 in a similar manner to that of the assembly of the conventional lower journal housing 18 to the conventional upper journal housing 20.

In order to further illustrate the present invention, the following examples are given. However, it is to be understood that the examples are for illustrative purposes only and are not to be construed as limiting the scope of the subject invention.

### EXAMPLES

### Example 1

Conventional Design of Journal Housing and Roll (CE/Alstom 1103)
   Oil Volume=79 quarts
   Cavity Pressure @ 180° F.=27.8 psi
   Total Weight=9354 lbs.
One embodiment of the grinding apparatus of the present invention
   Oil Volume=155 quarts
   Cavity Pressure @ 180° F.=13.6 psi
   Total Weight=8362 lbs.

### Example 2

Conventional Design of Journal Housing and Roll (CE/Alstom 1003)
   Oil Levels=25″ (low); 28″ (high)
   Oil Volume=42 qts. (low); 49 qts. (high)
   Cavity Pressure @ 180° F.=7.7 psi (low) 17.9 psi (high)
   Total Weight=6770 lbs.
Another embodiment of the grinding apparatus of the present invention
   Oil Levels=24″ (low); 27″ (high)
   Oil Volume=111 qts. (low); 122 qts. (high) Cavity Pressure @ 180° F.=8.2 psi (low); 13.9 psi (high) Total Weight=5900 lbs.
      For the examples, the greater the oil volume provides better lubrication to the grinding apparatus and upper journal housing. There is less seal wear with the lower cavity pressure and the lower weight provides lower inertial loading and lower main shaft stress.

One improvement of the grinding apparatus constructed in accordance with the present invention is the ability to reduce pressure in the oil chamber which extends the seal life of the grinding apparatus which extends the operating time and reduces costs. One failure point of a conventional journal assembly is due to higher pressure inside an oil chamber/cavity deteriorating seals to failure.

While the present invention is described herein utilized in a bowl mill pulverizer, it should be understood by one of ordinary skill in the art the apparatus and methods of the present invention may be readily applied to use with other suitable particulate size reduction processes and/or other suitable devices.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A grinding apparatus, comprising:
a housing capable of being removably attached to an upper journal housing of a pulverizer, the housing having an open first end, a closed second end, an outer peripheral surface, and a sidewall, wherein the outer peripheral surface has a grinding portion for grinding a solid fuel, and wherein the sidewall defines an oil chamber sized and configured to receive a shaft of the pulverizer.

2. The grinding apparatus of claim 1 wherein the first end of the housing has a flange portion having a plurality of holes for attachment of the housing to the upper journal housing.

3. The grinding apparatus of claim 1 wherein the second end of the housing is provided with an outwardly extending shoulder portion.

4. The grinding apparatus of claim 1 wherein the grinding portion is formed from tungsten carbide.

5. The grinding apparatus of claim 1 wherein the grinding portion is a weld overlay.

6. The grinding apparatus of claim 5 wherein the weld overlay is about 1.5 inches.

7. The grinding apparatus of claim 1 wherein the solid fuel is coal.

8. The grinding apparatus of claim 1 wherein the grinding portion is integrally formed as a portion of the housing.

9. The grinding apparatus of claim 1 wherein the sidewall extends outwardly from a proximal end to a distal end of the sidewall to form an outer portion of the oil chamber.

10. The grinding apparatus of claim 1 wherein the oil chamber is sized and configured to receive various sized shafts.

11. A method of attaching a grinding apparatus to a pulverizer for grinding a solid fuel, comprising the steps of:
providing the grinding apparatus, comprising:
a housing having an open first end, a closed second end, an outer peripheral surface, and a sidewall, wherein the outer peripheral surface has a grinding portion for grinding a solid fuel, and wherein the sidewall defines an oil chamber sized and configured to receive a shaft of the pulverizer; and
removably attaching the housing of the grinding apparatus to an upper journal housing of a pulverizer.

12. The method of claim 11, further comprising the step of:
removing a grinding roll of the pulverizer.

13. The method of claim 11, further comprising the step of:
removing a lower journal assembly of the pulverizer.

14. The method of claim 11, further comprising the step of:
disposing a shaft of the pulverizer into the oil chamber.

15. The method of claim 11 further comprising the step of:
filling the oil chamber of the housing with oil.

16. The method of claim 11, wherein the first end of the housing has a flange portion having a plurality of holes for attachment of the housing to the upper journal housing.

17. The method of claim 11 wherein the sidewall extends outwardly from a proximal end to a distal end of the sidewall to form an outer portion of the oil chamber.

18. The method of claim 11 wherein the housing is constructed of cast steel.

19. The method of claim 11 wherein the solid fuel is coal.

20. The method of claim 11 wherein the grinding portion of the housing is tungsten carbide.
